(19) United States
(12) Patent Application Publication
(10) Pub. No.: US 2026/0030135 A1
(43) Pub. Date: Jan. 29, 2026

(54) METHOD OF DETERMINING THE DATA ACQUISITION FREQUENCY FOR MONITORING A HIGH-PERFORMANCE COMPUTER

(71) Applicant: BULL SAS, Les Clayes-sous-Bois (FR)

(72) Inventors: Calliste HANRIAT, Saint Vincent de mercuze (FR); Cyprien PELISSE-VERDOUX, Grenoble (FR); Guillaume RAFFIN, La Tour-du-Pin (FR); Lionel BOUZON, Crêts-En-Belledonne (FR); Pierre SEROUL, Sinard (FR); Titouan JOUFFRAY, Grenoble (FR)

(73) Assignee: BULL SAS, Les Clayes-sous-Bois (FR)

(21) Appl. No.: 19/277,533

(22) Filed: Jul. 23, 2025

(30) Foreign Application Priority Data
Jul. 23, 2024 (EP) 24306243.7

(51) Int. Cl. G06F 11/34; G06F 11/30; G06N 20/00

(52) U.S. Cl. CPC G06F 11/3476; G06F 11/3006; G06F 11/3089; G06N 20/00

(57) ABSTRACT

The invention relates to a computer-implemented method of determining data acquisition frequencies for monitoring a computing infrastructure, the data being hardware and/or software characteristics of the computing infrastructure. The method includes acquiring, at a first predetermined frequency, a set of predetermined parameters, wherein each predetermined parameter of the set of predetermined parameters relates to a current operating state of the computing infrastructure. The method also includes, each time the set of predetermined parameters is acquired, determining an acquisition frequency for each monitoring data item among the monitoring data, by a trained supervised machine learning model taking the set of predetermined parameters as input. The method also includes acquiring each monitoring data item at the determined acquisition frequency and storing the monitoring data.

This application claims priority to European Patent Application Number 24306243.7 filed 23 Jul. 2024, the specification of which is hereby incorporated herein by reference.

### BACKGROUND OF THE INVENTION

### Field of the Invention

The technical field of at least one embodiment of the invention is that of high-performance computers.

At least one embodiment of the invention relates to a method of determining the data acquisition frequency of a high-performance computer and in particular of determining an optimum frequency for monitoring such a high-performance computer.

### Description of the Related Art

Optimizing the acquisition frequency of monitoring data in high-performance computing (HPC) systems is a key area of research for improving the efficiency and performance of these systems. Monitoring parameters such as computing resource utilization, memory, temperature and other performance indicators is fundamental to the correct functioning and maintenance of HPC infrastructures. The term “monitoring” is used in the present application to mean the continuous monitoring of hardware characteristics (temperature, power consumption, use of computing, memory and network resources) and software characteristics (use per process, per user, etc.), rather than the collection of events (log files, etc.).

Historically, various methods and technologies have been developed for collecting and analyzing monitoring data. Among these, traditional monitoring systems in HPC environments have often been designed to collect data at fixed time intervals, independently of system operating conditions. Although simple to implement, this approach has proved ineffective. For example, an acquisition frequency that is too high can overload the computing system by generating an excessive volume of data, resulting in overloaded networks and storage systems. High-frequency monitoring will also prevent the system from entering energy-saving levels due to the demands placed on the system. Conversely, an acquisition frequency that is too low may miss critical events or rapid variations in system performance. There is thus a trade-off between the monitoring frequency and the impact of this monitoring on performance and storage.

To solve this problem, while maintaining a fixed acquisition frequency, many solutions have focused on optimized data storage:
Databases with compression: to get round the storage problems associated with fine, high-frequency monitoring, some databases offer data compression models,
Databases with retention policies: another approach consists of concatenating (with loss of information) the oldest data,
Other solutions propose to remove irrelevant acquired data at source.

All these proposals have their drawbacks. At the exascale level, even compression algorithms do not make it possible to store the huge amount of data. Moreover, without changing the acquisition frequency, the impact of the monitoring remains too great on HPC performance. Retention makes it possible to manage the storage problem but not that of the impact on system performance. Moreover, the loss of granularity in the data is not based on the information contained in these data but on the age of the data item.

To avoid having to resort to these solutions, various research projects have explored the dynamic adaptation of the data acquisition frequency based on the state of the system. For example, some works have proposed algorithms based on predefined thresholds that adjust the frequency of data collection when a specific parameter exceeds a certain threshold. However, threshold-based approaches may lack flexibility and may not react optimally to changing system conditions, for example by reacting after the event has started. Indeed, the systems with frequency variation are both reactive and non-proactive, generating a delay between the variation of the data and that of the frequency. Moreover, this delay itself depends on the acquisition frequency. It is therefore variable and potentially very large (at low acquisition frequencies).

Thus, there is a need to develop more efficient and adaptive methods for optimizing the acquisition frequency of monitoring data in HPC systems.

### BRIEF SUMMARY OF THE INVENTION

At least one embodiment of the invention offers a solution to the above-mentioned problems, by providing a solution that dynamically and intelligently optimizes the data collection frequency, taking into account the actual conditions and specific requirements of each high-performance computer.

At least one embodiment of the invention relates to a method, implemented by a computer, for determining acquisition frequencies of monitoring data for a computing infrastructure, the acquired data being hardware and/or software characteristics of the computing infrastructure, the method comprising:
Acquiring, at a first predetermined frequency, a set of predetermined parameters, each predetermined parameter of the set of predetermined parameters relating to a current operating state of the computing infrastructure,
Each time the set of predetermined parameters is acquired, an acquisition frequency is determined for each monitoring data item among the monitoring data, by a trained supervised machine learning model taking the set of predetermined parameters as input,
Acquiring each monitoring data item at the determined acquisition frequency,
Storing monitoring data.

By virtue of one or more embodiments of the invention, it is possible to obtain and use an optimal monitoring data acquisition frequency, that is adaptive and dependent on predetermined external parameters of the computing infrastructure and not on the occurrence of events, allowing proactive acquisition frequency adaptivity, as opposed to the reactive adaptivity based on the occurrence of events proposed in the state of the art.

By acquiring a set of predetermined parameters at a fixed, low frequency during inference, at least one embodiment of the invention guarantees a collection of relevant operational data without overloading the computing infrastructure, thus having a low performance impact on system performance.

The use of a supervised machine learning model to determine the optimum frequency of data acquisition based on the parameters collected allows a dynamic and adaptive approach to monitoring computing infrastructure. This model, trained on historical data, predicts the most appropriate monitoring data acquisition frequency for each acquisition of the set of predetermined parameters, thus in near-real time, ensuring that the monitoring is both effective and proactive based on the current state of the computing infrastructure. This adaptability helps to capture critical events and variations in system performance that might be missed with a fixed-frequency approach, or with an adaptive-frequency approach that is reactive to detected events.

Acquiring monitoring data at the determined optimum frequency ensures that the monitoring process is tailored to the needs of the system, thus reducing the collection and storage of unnecessary data while capturing essential performance metrics. This allows subsequent maintenance of the computing infrastructure or management of the energy consumption of the computing infrastructure with less reduction in computing infrastructure performance than in the background art.

In addition to the features mentioned in the preceding paragraphs, the method according to one or more embodiments of the invention may have one or more complementary features from the following, taken individually or according to all technically plausible combinations:
The method further comprises beforehand:
   Acquiring, at the first predetermined fixed frequency, a set of predetermined training parameters,
   Storing the set of predetermined training parameters acquired,
   Acquiring training monitoring data at a second predetermined fixed frequency, the second fixed frequency being equal to a maximum monitoring frequency determined by inference and being greater than the first predetermined fixed frequency,
   Storing the acquired training monitoring data,
   training the supervised machine learning model from the set of predetermined training parameters acquired and the set of training monitoring data acquired.
   training the supervised machine learning model comprises, for each training parameter acquisition interval, separating two acquisitions of the set of predetermined training parameters:
   Determining the monitoring data acquisition frequencies corresponding, for each monitoring data item, to a maximum amplitude frequency of a spectrum obtained by the Fourier transform of a signal formed by the training monitoring data item acquired over the training parameter acquisition interval. This makes it possible to optimize the monitoring data acquisition frequency by determining a maximum amplitude frequency from a spectrum obtained by the Fourier transform of the training monitoring data. This approach ensures that the acquisition frequency is adjusted to capture the most significant variations in the data, thus improving the accuracy and the relevance of the information collected. Using spectral analysis, at least one embodiment of the invention identifies the dominant frequency components, allowing the detection of critical events and rapid variations in the computing infrastructure performance.
   training the supervised machine learning model comprises, for each training parameter acquisition interval, separating two acquisitions of the set of predetermined training parameters for each training monitoring data item:
   Integrating frequency amplitudes of a spectrum obtained by the Fourier transform of a signal formed by the training monitoring data item acquired over the training parameter acquisition interval,
   Determining the monitoring data acquisition frequency corresponding to a predetermined frequency amplitude integration threshold.
   the predetermined threshold is between 75% and 99%.
   the supervised machine learning model is configured to predict continuous frequencies, the supervised machine learning model being a regression tree.
   the supervised machine learning model is configured to predict discrete frequencies, the supervised machine learning model being a classification tree.
   the monitoring data comprise at least one of the following data items:
   the use of at least one compute node of the computing infrastructure,
   the use of at least one storage node of the computing infrastructure,
   the use of at least one input/output of the computing infrastructure,
   the power consumption of at least one resource of the computing infrastructure,
   the temperature of at least one resource of the computing infrastructure.
   the predetermined parameters comprise at least one of the following data items:
   the presence of computing work on a node of the computing infrastructure,
   the number, the name or the state of active processes in the computing infrastructure,
   a sleep state of the compute nodes of the computing infrastructure.

At least one embodiment of the invention relates to a method of maintaining a computing infrastructure comprising the method of determining a frequency of acquisition of monitoring data according to the one or more embodiments of the invention, the maintenance method comprising a schedule for maintaining a resource of the computing infrastructure based on the acquired and stored monitoring data.

At least one embodiment of the invention relates to a method of saving energy in a computing infrastructure comprising the method of determining a frequency of acquisition of monitoring data according to one or more embodiments of the invention, the method of saving energy comprising the issuing of a notification to put a resource of the computing infrastructure to sleep based on the acquired and stored monitoring data.

At least one embodiment of the invention relates to a high-performance computer comprising a computer configured to implement a method according to one or more embodiments of the invention.

At least one embodiment of the invention relates to a computer program product comprising instructions which, when the program is executed by a computer, result in the latter implementing a method according to one or more embodiments of the invention.

At least one embodiment of the invention relates to a computer-readable data medium on which the computer program product according to one or more embodiments of the invention is saved.

The one or more embodiments of the invention and its different applications will be better understood upon reading the following disclosure and examining the accompanying figures.

### BRIEF DESCRIPTION OF THE DRAWINGS

The figures are presented by way of reference and are in no way limiting to the at least one embodiment of the invention.

FIG. 1 shows a schematic depiction of one embodiment of a method according to one or more embodiments of the invention.

FIG. 2 shows a schematic depiction of a computing infrastructure for implementing a method according to one or more embodiments of the invention.

FIG. 3 shows a schematic depiction of a step of an embodiment of a method according to one or more embodiments of the invention.

FIG. 4 shows a schematic depiction of training a model according to a first example of one or more embodiments of the invention.

FIG. 5 shows a schematic depiction of training a model according to a second example of one or more embodiments of the invention.

FIG. 6 shows a schematic depiction of a step of a method according to one or more embodiments of the invention.

FIG. 7 shows a schematic depiction of a system for implementing a method according to one or more embodiments of the invention.

### DETAILED DESCRIPTION OF THE INVENTION

The one or more embodiments of invention described below provides an optimum frequency for acquiring monitoring data in a computing infrastructure.

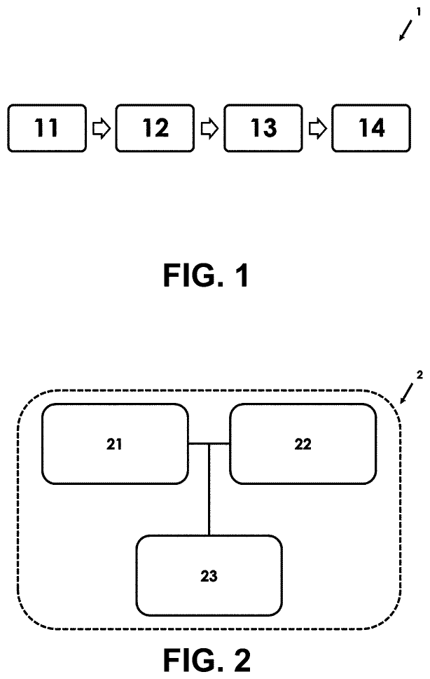

FIG. 1 shows a schematic depiction of a method according to one or more embodiments of the invention.

The method 1 according to one or more embodiments of the invention is a computer-implemented method for determining an acquisition frequency of monitoring data for a computing infrastructure.

The computing infrastructure is, for example, preferentially a high-performance computer. Such a computing infrastructure is shown schematically in FIG. 2, by way of one or more embodiments.

The computing infrastructure 2 shown in FIG. 2 comprises at least one compute node 21, a storage node 22 and a monitoring module 23. The monitoring module 23 is for example a software module or a physical device configured to run a software module. The monitoring module 23 performs monitoring actions on the computing infrastructure 2.

The method 1 according to one or more embodiments of the invention is therefore implemented by the monitoring module 23, for example because the monitoring module 23 is a computer. The monitoring module 23 can then be included in the computing infrastructure 2, or be an element external to the computing infrastructure 2. In this second case, it is for example connected to the computing infrastructure 2 via a network.

A method is said to be “computer-implemented” when the method is stored in a memory of the computer in the form of instructions which, when executed by a computer processor, result in the processor and therefore the computer implementing the method.

The monitoring module 23 is configured to monitor the computing infrastructure 2. To do this, it implements the method 1 according to one or more embodiments of the invention.

The method 1 according to one or more embodiments of the invention comprises a first step 11 of training a supervised machine learning model.

The trained supervised machine learning model is for example of the multi-output regression tree or multi-output classification tree type, based on the desired output format (continuous frequency or discrete frequency respectively). The at least one embodiment of the invention is of course not limited to these types of machine learning models and any suitable supervised machine learning model could be used.

Hereafter, when an element is said to be “predetermined”, this means that it has been defined prior to its use, for example by being accessible in a configuration file, the predetermination having been carried out for example manually by an operator or automatically by software.

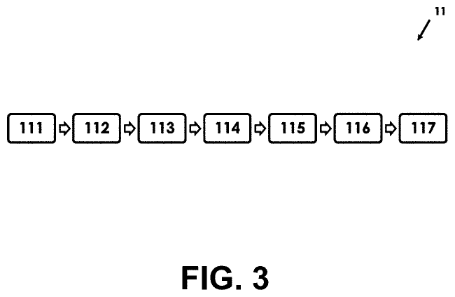

This first step 11 is shown schematically in FIG. 3, which shows a plurality of sub-steps, according to one or more embodiments of the invention.

The data acquisition steps comprise at least the reception of the data by the computer implementing the one or more embodiments of the invention, for example via a computer network, either wired or wireless. An acquisition is preferentially active, that is initiated by the computer implementing the method 1, for example performed at a predetermined frequency from a predetermined resource.

A sub-step 111 of step 11 comprises an acquisition, at a first predetermined fixed frequency, of values of a set of predetermined training parameters. The set of predetermined parameters acquired during training, as during inference, is a set of parameters external to the computing infrastructure 2. A parameter external to the computing infrastructure 2 is a variable or an indicator that is not directly related to the internal characteristics of the system, but which influences or reflects the overall operating state of the computing infrastructure 2. In this respect, it relates to a current operating state of the computing infrastructure 2. These external parameters can comprise, but are not limited to, at least one of the following parameters: the presence of computing work on a node, the number of active processes in the computing infrastructure 2, their name and their state, the sleep state of compute nodes, and/or any other external parameter relevant to the calculation of the monitoring frequency. The names of processes are for example encoded in vector form. These external parameters are essential for defining a context for the monitoring to be carried out and allow the frequency of monitoring data acquisition to be dynamically adjusted based on operational needs and on system operating conditions.

The first predetermined fixed frequency is called Fp and is preferentially between 0.1 Hz and 1 Hz. This frequency of acquisition of predetermined parameters during training is identical to the frequency of acquisition of predetermined parameters during inference. The first acquisition frequency Fp defines an interval whose period is

$${T}_{P} = \frac{1}{{F}_{P}} .$$

With the frequency range Fp [0.1 Hz; 1 Hz], the interval has a time duration of between 1 second and 10 seconds.

In a sub-step 112, the set of predetermined training parameter values acquired in sub-step 111 is stored, for example in a memory of the computer implementing the method 1, or in a storage node of the computing infrastructure 2, or in a storage means included in or external to the computing infrastructure 2.

Then, or in parallel with sub-steps 111 and 112, a sub-step 113 of step 11 comprises an acquisition, at a second predetermined fixed frequency Fmax, of training monitoring data values. The monitoring data acquired during training, as during inference, are predetermined and are internal characteristics of the computing infrastructure 2 that are monitored to evaluate and optimize the performance and the efficiency of the computing infrastructure 2. These metrics include, but are not limited to, the use of resources such as the compute nodes, the graphics nodes, the storage nodes, and the inputs/outputs (IO), the power consumption, the temperature of the computing infrastructure 2, and any other technical parameter specific to the computing infrastructure 2 that makes it possible to report on its operating state at an acquisition time. The metrics provide detailed information on the operating state of the computing infrastructure 2 and are used to identify bottlenecks, optimize resource utilization and prevent potential failures. By monitoring these metrics, it is possible to make informed decisions in order to improve the overall performance and the energy efficiency of the computing infrastructure 2.

The second predetermined fixed frequency Fmax is equal to the maximum monitoring frequency determinable by inference. Moreover, the fixed frequency Fmax is greater than the first predetermined fixed frequency, so that Fmax>Fp. For example, Fmax can be between 100 Hz and 10 KHz.

After sub-step 113, and optionally in parallel with sub-steps 111 and 112, in a sub-step 114, the set of predetermined training monitoring data values acquired in sub-step 113 is stored, for example in a memory of the computer implementing the method 1, or in a storage node of the computing infrastructure 2, or in a storage means included in or external to the computing infrastructure 2.

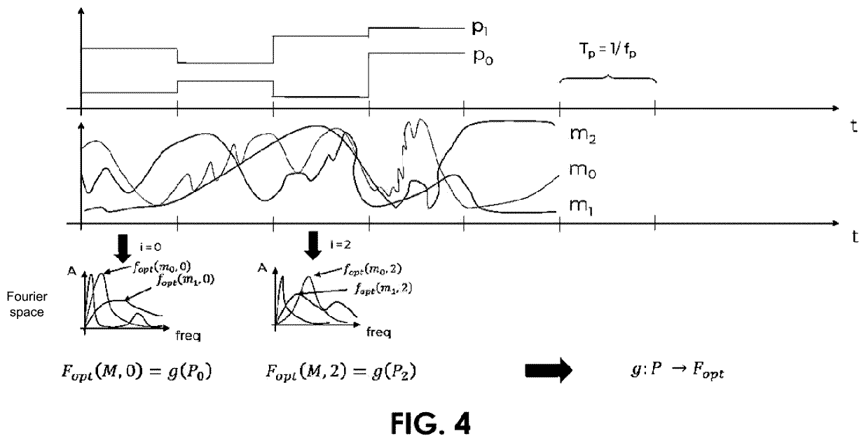

In the method 1 according to one or more embodiments of the invention, a sub-step 115 of step 11 then comprises a calculation of a Fourier transform of the time signal formed by the monitoring data acquired and stored in sub-steps 113 and 114. The Fourier transform is calculated for each different monitoring data item, and over each predetermined parameter acquisition interval. Thus, if the fixed frequency Fp of acquisition of predetermined parameters is 1 Hz, each interval will have a duration of 1 second. At least one embodiment of the invention therefore comprises the calculation of the Fourier transform associated with a single value for each predetermined parameter, since the Fourier transform of the monitoring data is calculated over the selected sampling rate of the predetermined parameters. This is represented schematically in FIG. 4, by way of one or more embodiments of the invention, which shows two predetermined parameters p0 and p1, whose values are acquired at the first predetermined fixed frequency Fp. Each of the parameters p0 and p1 therefore has a unique value over each time interval

$${T}_{P} = \frac{1}{{F}_{P}} .$$

Over each interval, the Fourier transform of each time signal m0, m1 and m2 formed by the acquired and stored monitoring data is calculated, as shown in the lower part of FIG. 4, in at least one embodiment. The Fourier transform can for example be calculated using a Fast Fourier Transform (FFT) function, because the digital signal formed by the monitoring data is a discrete signal.

A frequency of acquisition of the monitoring data to be used for inference is then selected in a sub-step 116, for each monitoring data item, from the spectrum of the training monitoring data derived from the Fourier transform.

This selection 116 can be carried out in two ways, and therefore according to two examples, according to one or more embodiments of the invention. In a first example, the monitoring data acquisition frequency selected in sub-step 116 to train the model is the maximum amplitude frequency of the spectrum obtained by the Fourier transform. In other words, for each monitoring data item E in an interval, the optimal acquisition frequency is calculated as being the maximum amplitude frequency in Fourier space, where M is the set of monitoring data acquired and stored in sub-steps 113 and 114.

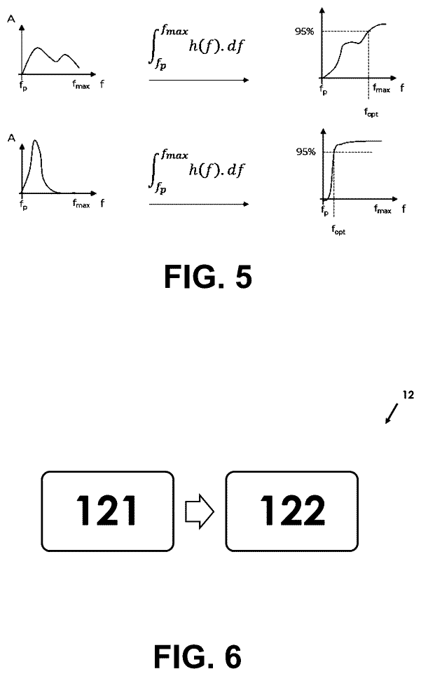

In a second example of sub-step 116, to select the acquisition frequency, an integral is first calculated over the frequency, between the limits Fp and Fmax, of the spectrum of the signal formed by the training monitoring data obtained by the Fourier transform. The selected acquisition frequency is then the frequency corresponding to a predetermined integration threshold. For example, as shown schematically in FIG. 5 by way of one or more embodiments, in both examples the frequency fopt selected is the frequency corresponding to a 95% threshold of the integral. With this method, 95% of the total signal energy is captured, while the optimized frequency is often well below the maximum frequency. This eliminates the frequencies that contribute least to the signal. Preferentially, the threshold selected is between 75% and 99%.

In a sub-step 117, the selected machine learning model is trained with, over all intervals Tp, the set of predetermined training parameter values acquired and stored in sub-steps 111 and 112 associated with the set of monitoring data acquisition frequencies selected in sub-step 116 for each monitoring data item. The result is a function g associating, over each predetermined parameter acquisition interval, a set of monitoring data acquisition frequencies Fopt with a set of predetermined parameter values P.

Once the model g has been trained, the method 1 according to one or more embodiments of the invention comprises at least one inference step 12. This step 12 is represented schematically in FIG. 6, according to one or more embodiments of the invention.

Inference is the process during which the trained machine learning model is used to obtain a new data item from data of the same type as the training data. In one or more embodiments of the invention, the trained model g is used to obtain a monitoring data acquisition frequency from acquired predetermined parameters.

Thus, step 12 comprises a first sub-step 121 of acquiring, at the first predetermined frequency Fp, a set of predetermined parameters. A new set of predetermined parameters is acquired every

$${T}_{P} = \frac{1}{{F}_{P}} .$$

At each acquisition time, a new value for each predetermined parameter of the set of predetermined parameters is acquired. The set of predetermined parameters acquired during inference 12 is identical to the set of predetermined training parameters from step 11, that is each parameter acquired is the same parameter as the parameter acquired in training 11, only its value may differ. “Value” is understood to mean a specific numerical or qualitative measurement that a parameter can take. A parameter is a measurable variable or characteristic that is used to describe a specific aspect of the computing infrastructure 2. Thus, the “value” of a parameter is the particular data item it takes on in a given context.

Unlike training 11, the set of predetermined parameters acquired in the inference step 12 is not stored. Indeed, storage is not necessary, as the model g is already trained and the data can be provided as input to the model g without having been stored beforehand. This notably reduces the impact of the method 1 on the performance of the computing infrastructure 2.

Step 12 comprises a second sub-step 122 determining monitoring data acquisition frequencies for each acquisition of the set of predetermined parameters of sub-step 121. This determination is therefore carried out every

$${T}_{P} = \frac{1}{{F}_{P}}$$

at least in part by the trained supervised machine learning model g, which takes as input the set of predetermined parameters acquired in sub-step 121 and estimates as output a monitoring data acquisition frequency Facq_est, by virtue of its training. An acquisition frequency is estimated for each monitoring data item in the set of monitoring data to be acquired, and each acquisition frequency may therefore be different from the others (or may be identical). A set of acquisition frequencies is therefore obtained.

For each monitoring data item, the monitoring data acquisition frequency actually used Facq, that is that which will be considered as “determined” at the end of sub-step 121, is calculated as being at least twice the frequency estimated Facq_est by the model g, in order to limit the loss of information by respecting the Shannon criterion. Preferentially, the final acquisition frequency is equal to twice the acquisition frequency estimated by the trained model g: F_{acq}=2*F_{acq_est}.

As the determination of the acquisition frequencies Facq in sub-step 122 is carried out at each acquisition of a set of predetermined parameters, that is every Tp, and as the first fixed frequency Fp is low (for example between 0.1 and 1 Hz), it is important that the model g selected is capable of estimating an acquisition frequency over this time interval Tp, and therefore that the model requires limited computing resources. This is why decision tree type models are preferred to heavier models such as neural networks. Any type of model g can be used in one or more embodiments of the invention, as long as it is capable of estimating an acquisition frequency from the set of predetermined parameters within a time interval Tp.

Having determined the monitoring data acquisition frequencies Facq, the method 1 according to one or more embodiments of the invention comprises a step 13 of acquiring monitoring data at each acquisition frequency Facq determined in step 11. Each monitoring data item in the set of monitoring data is acquired at the determined acquisition frequency associated therewith. The monitoring data acquired is the same monitoring data as in training 11, only the value thereof may differ. “Value” is understood to mean a specific numerical or qualitative measurement that a monitoring data item can take. A monitoring data item is a measurable variable or characteristic that is used to represent the operation of a resource of the computing infrastructure 2. Thus, the “value” of a monitoring data item is the particular data item it takes on in a given context. The monitoring data acquired in step 13 may be acquired in the same way as in training, or differently, for example directly from the monitored resources of the computing infrastructure 2 whereas in training they were acquired from a training database, for example. At least one embodiment of the invention therefore makes it possible to have a variable acquisition frequency which is proactive (and not reactive, after the occurrence of events) and which is adapted to the context of the computing infrastructure 2 by taking into account predetermined parameters reflecting the operating state of the computing infrastructure 2.

The monitoring data acquired in step 13 are then stored in step 14. This storage can be carried out in any way known to the skilled person, for example in a monitoring database, which may or may not be part of the computing infrastructure 2.

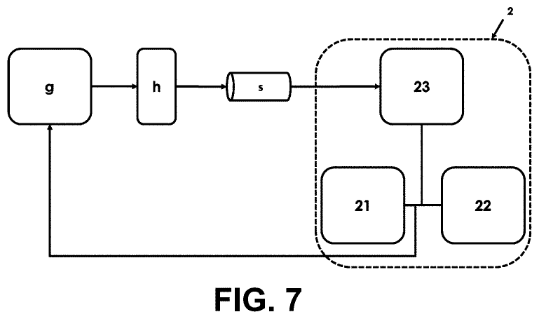

FIG. 7 shows a schematic depiction of a system allowing the use of the monitoring data acquired and stored by virtue of the method 1 according to one or more embodiments of the invention.

In this system, the output of the trained model g is sent to the monitoring module 23. Thus, the monitoring module 23 can perform the acquisition and storage actions of the monitoring data at the frequencies determined by the model g or at the frequencies determined on the basis of the estimate made by the model g. To do this, it is possible to use a connector s, for example of the socket type, for example according to the Internet Protocol (IP) suite.

The system shown in FIG. 7, in at least one embodiment, further comprises an optional hysteresis module h, to avoid permanent frequency changes. The optional hysteresis module h compares the determined acquisition frequency with a predefined threshold, for example a so-called threshold “A”. As long as the determined acquisition frequency is less than threshold A, the acquisition frequency actually used is the current acquisition frequency, that is the acquisition frequency already directly used previously to acquire the monitoring data. If the determined acquisition frequency is greater than threshold A, then the current frequency is increased to become the determined acquisition frequency. Similarly, a predefined threshold “B” can be used, to decrease the acquisition frequency only if the determined acquisition frequency does not fall below this threshold B. The second threshold B prevents excessive frequency changes if the determined acquisition frequency oscillates around the first threshold A.

The monitoring module 23 then performs the acquisition of the monitoring data at the determined acquisition frequencies, and can then be configured to implement actions linked to these acquired and stored monitoring data.

For example, the monitoring module 23 or another module of the computing infrastructure 2, can be configured to implement a method of maintaining the computing infrastructure 2 comprising, from the monitoring data acquired at the acquisition frequencies determined by the method according to one or more embodiments of the invention and stored, the implementation of a schedule for maintaining a resource of the computing infrastructure 2. This can be implemented by using another machine learning model configured to detect, from the monitoring data, the occurrence of a failure of a resource of the computing infrastructure, and/or for example to perform predictive maintenance.

Alternatively or cumulatively, for example, the monitoring module 23 or another module of the computing infrastructure 2, can be configured to implement an energy-saving process for the computing infrastructure 2, the energy-saving process comprising the issuing of a notification to put a resource of the computing infrastructure to sleep based on the acquired and stored monitoring data, the notification being sent to the resource to be put to sleep. Numerous energy-saving processes are known to the skilled person and can be used in at least one embodiment of the invention, based on the monitoring data acquired at the acquisition frequencies determined by the method according to one or more embodiments of the invention.

1. A computer-implemented method for determining acquisition frequencies of monitoring data for a computing infrastructure, the monitoring data being one or more of hardware and software characteristics of the computing infrastructure, the computer-implemented method comprising:
acquiring, at a first predetermined frequency, a set of predetermined parameters, each predetermined parameter of the set of predetermined parameters relating to a current operating state of the computing infrastructure,
each time the set of predetermined parameters is acquired, determining an acquisition frequency for each monitoring data item among the monitoring data, by a trained supervised machine learning model taking the set of predetermined parameters as input,
acquiring the each monitoring data item at the acquisition frequency that is determined,
storing the monitoring data.

2. The computer-implemented method according to claim 1, further comprising, as prior steps.
acquiring, at the first predetermined frequency, a set of predetermined training parameters,
storing the set of predetermined training parameters that are acquired (111),
acquiring training monitoring data at a second predetermined frequency, the second predetermined frequency being equal to a maximum monitoring frequency determined by inference and being greater than the first predetermined frequency,
storing the training monitoring data (113) acquired,
training the trained supervised machine learning model from the set of predetermined training parameters that is acquired and the training monitoring data that is acquired.

3. The computer-implemented method according to claim 2, wherein the training of the trained supervised machine learning model comprises, for each acquisition interval of training parameters separating two acquisitions of the set of predetermined training parameters:
determining monitoring data acquisition frequencies corresponding, for said each monitoring data item, to a maximum amplitude frequency of a spectrum obtained by a Fourier transform of a signal formed by a training monitoring data item acquired over a training parameter acquisition interval of said each acquisition interval.

4. The computer-implemented method according to claim 2, wherein the training of the trained supervised machine learning model comprises, for each acquisition interval of training parameters separating two acquisitions of the set of predetermined training parameters and for each training monitoring data item:
integrating frequency amplitudes of a spectrum obtained by a Fourier transform of a signal formed by a training monitoring data that is acquired over a training parameter acquisition interval of said each acquisition interval,
determining monitoring data acquisition frequency corresponding to a predetermined frequency amplitude integration threshold.

5. The computer-implemented method according to claim 4, wherein the predetermined frequency amplitude integration threshold is between 75% and 99%.

6. The computer-implemented method according to one claim 1, wherein the trained supervised machine learning model is configured to predict continuous frequencies, the trained supervised machine learning model being a regression tree.

7. The computer-implemented method according to claim 1, wherein the trained supervised machine learning model is configured to predict discrete frequencies, the trained supervised machine learning model being a classification tree.

8. The computer-implemented method according to claim 1, wherein the monitoring data comprise at least one of
use of at least one compute node of the computing infrastructure,
use of at least one storage node of the computing infrastructure,
use of at least one input/output of the computing infrastructure,
power consumption of at least one resource of the computing infrastructure,
temperature of at least one resource of the computing infrastructure.

9. The computer-implemented method according to claim 1, wherein the set of predetermined parameters comprise at least one of
presence of computing work on a node of the computing infrastructure,
number,
a name or
a state of active processes in the computing infrastructure,
a sleep state of compute nodes of the computing infrastructure.

10. The computer-implemented method according to claim 1, further comprising maintaining the computing infrastructure via a schedule that maintains a resource of the computing infrastructure based on the monitoring data that is acquired and that is stored.

11. The computer-implemented method according to claim 1, further comprising saving energy in the computing infrastructure comprising issuing a notification to put a resource of the computing infrastructure to sleep based on the monitoring data that is acquired and that is stored.

12. A high-performance computer comprising:
a computer configured to implement a computer-implemented method for determining acquisition frequencies of monitoring data for a computing infrastructure, the monitoring data being one or more of hardware and software characteristics of the computing infrastructure, the computer-implemented method comprising
acquiring, at a first predetermined frequency, a set of predetermined parameters, each predetermined parameter of the set of predetermined parameters relating to a current operating state of the computing infrastructure,
each time the set of predetermined parameters is acquired, determining an acquisition frequency for each monitoring data item among the monitoring data, by a trained supervised machine learning model taking the set of predetermined parameters as input,
acquiring the each monitoring data item at the acquisition frequency that is determined,
storing the monitoring data.

13. A non-transitory computer program product comprising instructions that, when the non-transitory computer program product is executed by a computer, the computer implements a computer-implemented method determining acquisition frequencies of monitoring data for a computing infrastructure, the monitoring data being one or more of hardware and software characteristics of the computing infrastructure, the computer-implemented method comprising
acquiring, at a first predetermined frequency, a set of predetermined parameters, each predetermined parameter of the set of predetermined parameters relating to a current operating state of the computing infrastructure,
each time the set of predetermined parameters is acquired, determining an acquisition frequency for each monitoring data item among the monitoring data, by a trained supervised machine learning model taking the set of predetermined parameters as input,
acquiring the each monitoring data item at the acquisition frequency that is determined,
storing the monitoring data.

14. The non-transitory computer program product according to claim 13, wherein the non-transitory computer program product is stored on a non-transitory computer-readable data medium.
